(19) United States
(12) Patent Application Publication
(10) Pub. No.: US 2009/0150759 A1
(43) Pub. Date: Jun. 11, 2009

(54) Method and apparatus for browsing content-based documents

(75) Inventors: Ji-hye Chung, Seoul (KR); Hye-jeong Lee, Seoul (KR); Jong-ho Lea, Seongnam-si (KR); Yeun-bae Kim, Seongnam-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/081,406

(22) Filed: Apr. 15, 2008

(30) Foreign Application Priority Data
Dec. 7, 2007 (KR) 10-2007-0127152

(51) Int. Cl. G06F 17/00

(52) U.S. Cl. 715/200

(57) ABSTRACT

A method and apparatus for browsing content-based documents are provided. The method includes analyzing documents to generate a document tree on the basis of content-based components, and presenting the documents on the basis of the generated document tree to be adaptive to a browsing environment. Thus, the method can be applied to a browsing environment having various platforms and display devices without having to reproduce the web documents.

### CROSS REFERENCE TO RELATED APPLICATIONS

This application claims priority from Korean Patent Application No. 10-2007-0127152, filed on Dec. 7, 2007, the disclosure of which is incorporated herein in its entirety by reference.

### BACKGROUND OF THE INVENTION

1. Field of the Invention

The present invention relates to a browsing method and apparatus, and more particularly, to a method and apparatus for browsing web documents, which can be applied to a browsing environment having various platforms and display devices. The present invention can be applied to any web-browsable apparatus, which is connected to the Internet.

2. Description of the Related Art

In general, users obtain various pieces of information from web documents using a computer. Using web browsers particularly suitable for personal computers, such as Internet Explorer and Netscape, users obtain information from the web documents. The web documents are produced to be optimized to the computers, and are provided to the users through the web browsers.

Recently, due to an increase in amount of the information obtained on the World Wide Web and leisure time of the users, the number of users who want to browse the web documents in a browsing environment having various platforms and display devices has also increased. There is an increased demand to browse the web documents in a browsing environment having various platforms and display devices, for example, a browsing apparatus that has a portable display device with restricted resources and small size, such as a portable multimedia player (PMP), a mobile phone, an ultra mobile personal computer (UMPC), and so on, or an Internet protocol television (IPTV) having a large display device.

However, there is a limitation to meeting this demand of the users to produce the existing web documents for computers to be suitable for each environment.

### SUMMARY OF THE INVENTION

The present invention provides a method and apparatus for browsing content-based documents, which can be applied to a browsing environment having various platforms and display devices without having to reproduce the web documents.

Additional aspects of the invention will be set forth in the description which follows, and in part will be apparent from the description, or may be learned by practice of the invention.

According to an aspect of the present invention, the present invention discloses a method for browsing content-based documents, including: analyzing documents to generate a document tree on the basis of content-based components; and presenting the documents on the basis of the generated document tree to be adaptive to a browsing environment.

Here, the generating of the document tree may include grouping the content-based components into at least one component group according to a semantic relation; and providing the component group with at least one attribute suitable for the browsing environment.

Further, the generating of the document tree may further include adjusting a presentation priority for the content-based components or the component groups to be suitable for the browsing environment.

In addition, the presenting of the documents may include rendering the documents on the basis of the generated document tree according to the attribute bestowed to be suitable for the browsing environment.

According to another aspect of the present invention, the present invention discloses an apparatus for browsing content-based documents, including a browser engine for analyzing documents to generate a document tree on the basis of content-based components; and a rendering engine for presenting the documents on the basis of the generated document tree to be adaptive to a browsing environment.

According to yet another aspect of the present invention, the present invention discloses a mobile terminal or an Internet protocol television (IPTV) on which the apparatus for browsing content-based documents is mounted.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 illustrates the configuration of a browsing apparatus according to an exemplary embodiment of the present invention.

FIGS. 2 and 3 are reference diagrams illustrating the component structure of a document according to an exemplary embodiment of the present invention.

FIG. 4 is a flow chart illustrating a method for browsing web documents according to an exemplary embodiment of the present invention.

FIG. 5 is a reference diagram illustrating the structure of a document object model (DOM) tree.

FIG. 6 is a reference diagram illustrating a method of grouping components using a document structure according to an exemplary embodiment of the present invention.

FIG. 7 is a reference diagram illustrating the structure of a content-based component according to an exemplary embodiment of the present invention.

FIG. 8 is a reference diagram illustrating a document tree having a component structure according to an exemplary embodiment of the present invention.

### DETAILED DESCRIPTION OF EXEMPLARY EMBODIMENTS

The invention is described more fully hereinafter with reference to the accompanying drawings, in which exemplary embodiments of the invention are shown. The detailed descriptions of known function and construction unnecessarily obscuring the subject matter of the present invention will be avoided hereinafter. Further, technical terms, as will be mentioned hereinafter, are terms defined in consideration of their function in the present invention, which may be varied according to the intention or practices of a user or operator, so that the terms should be defined based on the contents of this specification.

In an exemplary embodiment of the present invention, a document will be described by taking a web page by way of example. This web page is merely provided for the convenience of description. Thus, the document is not limited to the web page, but includes all documents prepared with a markup language such as a hypertext markup language (HTML) or an extensible markup language (XML). In the exemplary embodiment of the present invention, an apparatus for browsing web documents is a comprehensive concept including a mobile terminal that supports the Internet, such as a portable multimedia player (PMP), a mobile phone, and an ultra mobile personal computer (UMPC), as well as an Internet protocol television (IPTV), and thus includes all digital apparatuses supporting the Internet. In the exemplary embodiment of the present invention, the method and apparatus for browsing web documents, which can be applied to the aforementioned browsing apparatuses without having to reproduce the web documents that have been optimally prepared for computers, are provided.

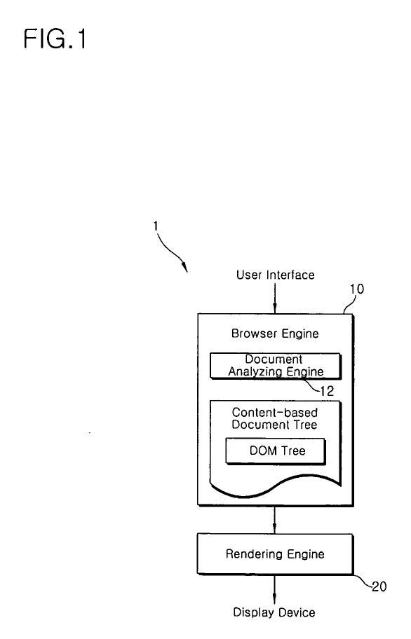

FIG. 1 illustrates the configuration of a browsing apparatus according to an exemplary embodiment of the present invention.

Referring to FIG. 1, the browsing apparatus 1 according to the present invention comprises a browser engine 10 and a rendering engine 20, and may further comprise a document analyzing engine 12, a user interface, and a display device.

The document analyzing engine 12 of the browser engine 10 analyzes existing web documents to generate a document tree on the basis of content-based components. In the present invention, the document tree based on the content-based components can be generated using a document object model (DOM) tree 14, which is generated by analyzing existing web documents. The document tree of the present invention reconstructs an existing tag-oriented DOM tree on the basis of the content-based components.

The browser engine 10 groups the content-based components into at least one component group according to a semantic relation, and provides the component group with at least one attribute suitable for a browsing environment. Here, the attribute provided so as to be suitable for the browsing environment preferably includes at least one of layout, presentation style, and content format of the document.

The browser engine 10 incorporates the plurality of content-based components into a representative component node in a parallel arrangement according to similarity such that the document tree has a flat structure. Thus, the correlation between the layout and the content of each document can be easily presented so as to be suitable for a document structure which a user recognizes, and make it easy for the user to understand and access the document structure. At this time, the representative component node includes summary information on content of the plurality of content-based components, and information on exposure levels of the plurality of content-based components. Further, the browser engine 10 groups the content-based components into the component groups according to the semantic relation using layouts or repeated patterns of the content-based components. A method of reconstructing the DOM tree to generate the document tree of the present invention will be described below in detail.

Further, the browser engine 10 adjusts a presentation priority for the content-based components or the component groups so as to be suitable for the browsing environment, so that it can adjust the exposure level of the content to a proper level according to the browsing environment. Furthermore, the browser engine 10 can search for or extract information of a specific content from the documents on the basis of the generated document tree.

Meanwhile, the rendering engine 20 presents the documents so as to be adaptive to the browsing environment on the basis of the generated document tree. In other words, the rendering engine 20 renders the documents to display on a display screen on the basis of the generated document tree according to the attribute, which is provided so as to be suitable for the browsing environment.

As described above, the exemplary embodiment of the present invention can provide the apparatus for browsing web documents, which can be applied to the browsing environment having various platforms and display devices without having to reproduce the web documents by analyzing the web documents to generate the document tree on the basis of the content-based components and rendering the documents on the basis of the generated document tree.

Hereinafter, the browsing method according to an exemplary embodiment of the present invention will be described in detail on the basis of the configuration of the aforementioned browsing apparatus.

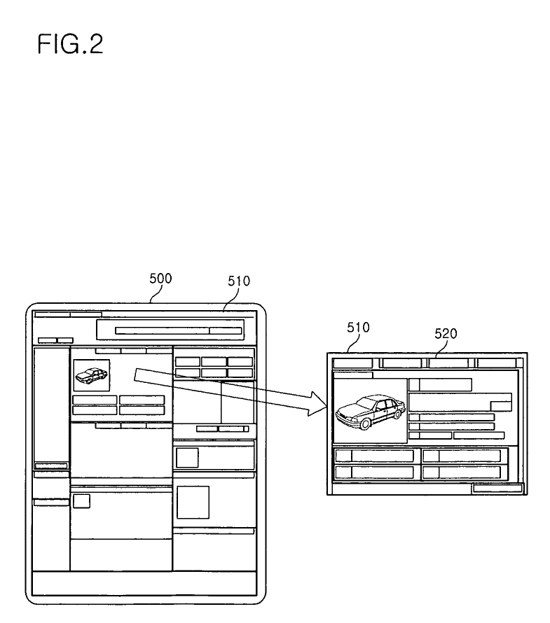

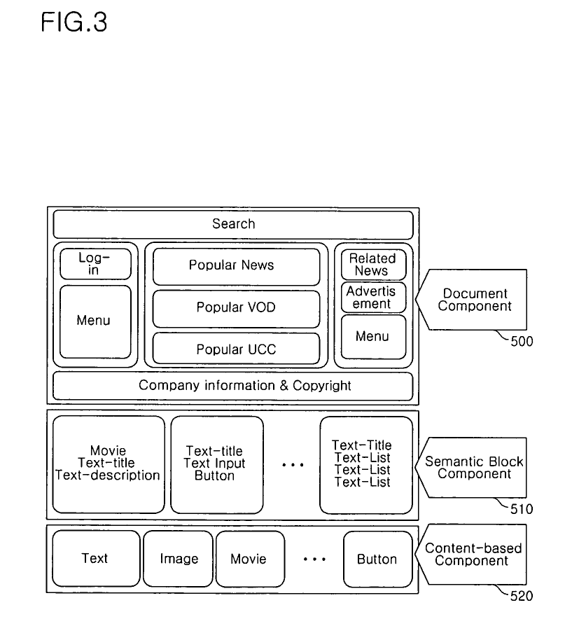

FIGS. 2 and 3 are reference diagrams illustrating the component structure of a document according to an exemplary embodiment of the present invention. As illustrated, the document tree according to an exemplary embodiment of the present invention includes three types of components: a content-based component 520; a semantic block component 510; and a document component 500.

First, the content-based component 520 (hereinafter, referred to as “first component”) is a lowest most basic unit of content, and includes a single media format such as text, image, video, button, input window, etc., and a presentation style.

Next, the semantic block component 510 (hereinafter, referred to as “second component”) is a component group that groups semantically related first components among a plurality of first components 520. The second component may further include another second component, in addition to the first components. The semantic relation can be inferred by analyzing the layout or pattern of each web document.

Finally, the document component 500 (hereinafter, referred to as “third component”) refers to all of the documents, and includes a plurality of second components. A plurality of third components are put together to constitute a web site.

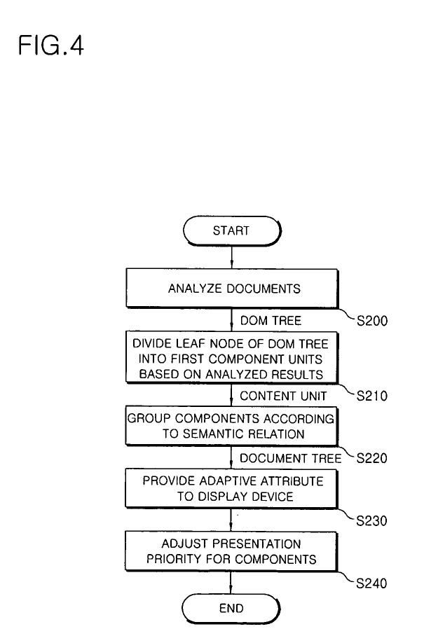

FIG. 4 is a flow chart illustrating a method for browsing web documents according to an exemplary embodiment of the present invention.

Referring to FIG. 4, the browser engine 10 of the present invention analyzes the existing web documents, which have been produced for computers, to generate a DOM tree in order to provide the web document browsing method, which can be applied to various browsing environments (S200).

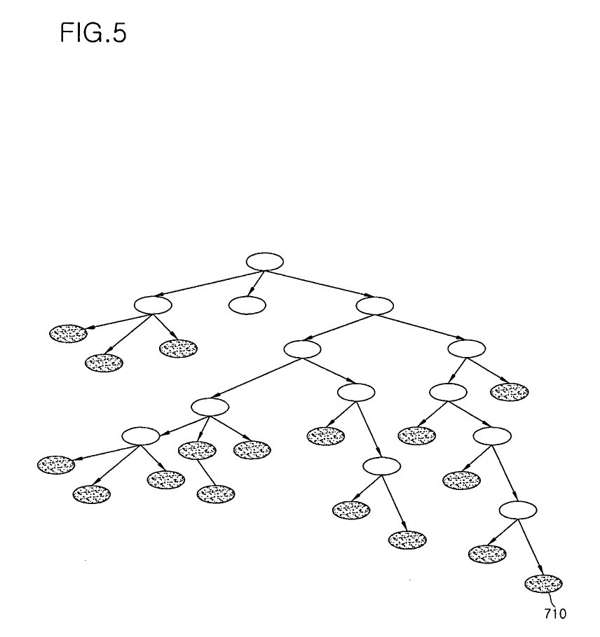

One example of a DOM tree structure is illustrated in FIG. 5. Referring to FIG. 5, the DOM tree hierarchically presents the documents using tags of the markup language such as HTML or XML. Nodes belonging to an intermediate level of the DOM tree do not store the content of the documents, but instead store the presentation styles, attributes, or the like for presenting the document content. The document content intended for presentation is actually stored in a leaf node 710, which occupies a lowest level of the DOM tree.

Thus, it is not until the user goes through a plurality of levels of the DOM tree that he/she can access the document content. Further, although many pieces of content have the same type, they are not frequently located at the same level of the DOM tree. In other words, many pieces of content having the same type are often separated and presented on the DOM tree. This is because the DOM tree has a layered structure on the basis of the tag regardless of the document content. As such, in order to browse the documents, which are produced so as to be suitable for the browsing environment for the computers, under another browsing environment, the documents must be reproduced.

In order to solve the problems of this existing browsing method using the DOM tree, the exemplary embodiment of the present invention provides a method of reconstructing a DOM tree to generate a document tree so as to be applicable to various browsing environments without having to reproduce the documents.

Referring again to FIG. 4, the browser engine 10 according to an exemplary embodiment of the present invention divides the leaf node of the DOM tree based on the tag into the first component units (S210). More specifically, the browser engine 10 can divide the leaf node of the existing DOM tree into the first component units according the media format such as text, image, video, etc. The browser engine 10 can also divide the leaf node of the existing DOM tree into the first component units according the presentation style such as font type, font size, color, background color, boundary, etc.

At this time, one first component is formed by checking the DOM tree in a bottom-up mode and then collecting many pieces of the divided unit content group by group on the basis of similarity of the media format or the presentation style. This is based on a result of observing that the more similar the content, the more similarly the media format or the presentation style becomes presented. In this manner, the DOM tree based on the tag is divided into the first component units having a high possibility of having similar content, and thereby the DOM tree is reconstructed.

Continuously, referring to FIG. 4, the plurality of divided first component units are grouped into at least one second component according to the semantic relation (S220). At this time, the first component units, which have semantic correlation, can be grouped using the layout, the repeated pattern, etc. of the web document.

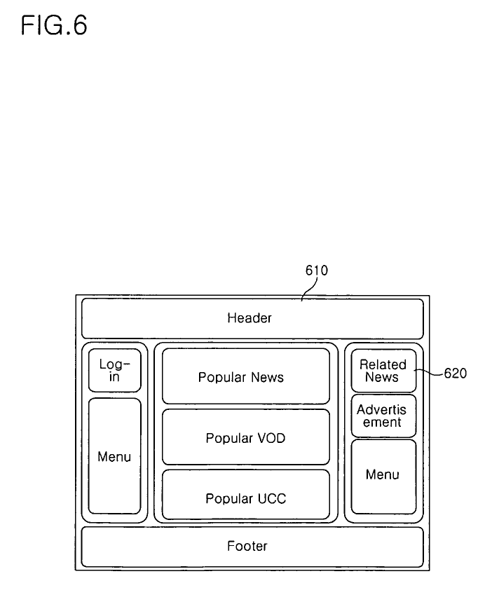

For example, a layout pattern such as header, left side, right side, center and footer is extracted using position, width and height, a margin, alignment, etc. of each component, and then the first components can be grouped using the extracted layout pattern. An example in which the components are grouped according to the semantic relation by extracting the layout pattern is illustrated in FIG. 6. Referring to FIG. 6, it can be found that first components 620 included in a third component 600 are grouped into a second component 610 according to the layout pattern. As another example, it is inferred whether or not there is a repeated pattern of a vertical or horizontal direction, and then the semantically related component units can be grouped.

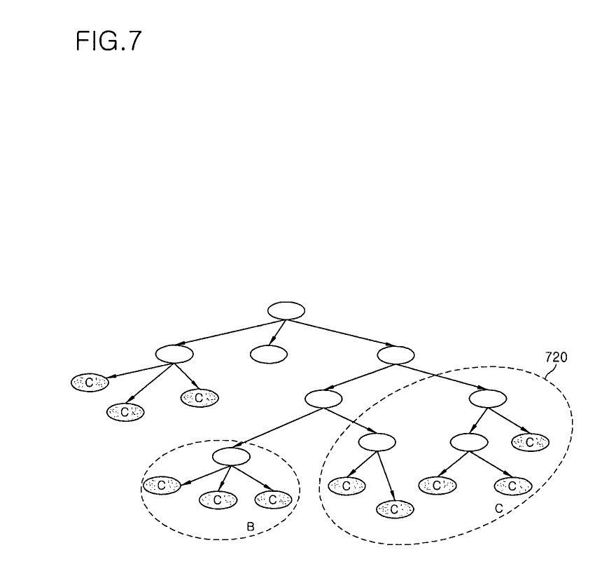

FIG. 7 is a reference diagram illustrating the structure of a content-based component according to an exemplary embodiment of the present invention. Referring to FIG. 7, the DOM tree is divided into the first components, and then the divided first components are grouped according to the semantic relation. Thereby, the DOM tree is reconstructed.

Referring again to FIG. 4, the first components or the grouped second components are provided with an attribute suitable for the browsing environment having various platforms or display devices (S230). Here, the attribute suitable for the browsing environment preferably includes at least one of layout, presentation style, and content format of the web document.

As described above, the layout can include region attributes -sorted as header, left side, right side, center and footer. The presentation style can include attributes such as font type, font size, color, background color, boundary, and so on. The content format can include a media format presented as text, image, video, and so on, and various presentation format that is provided with the content such as an interactive method presented as button, text input, list, radio button, check box, and so on, sorting based on the semantic relation, information on hyperlink connection, and so on.

Further, the browser engine 10 incorporates the plurality of first components into the representative component node in a parallel arrangement according to the similarity between the first components. At this time, the representative component node includes summary information on the content of each first component, and information on exposure levels of the plurality of first components.

The browser engine 10 adjusts a presentation priority for the first components or the grouped second components (S240). Thereby, the browser engine 10 can adjust the exposure level of the content according to size or characteristic of a display screen installed on the browsing apparatus. Furthermore, the browser engine 10 can search or extract information of a specific content from the documents on the basis of the generated document tree.

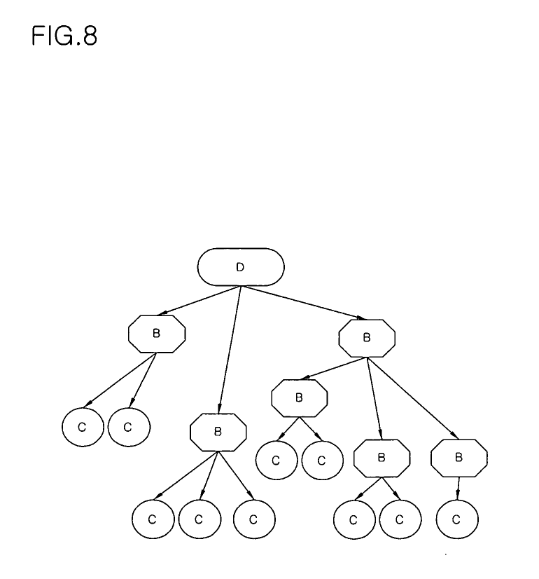

FIG. 8 is a reference diagram illustrating a document tree having a component structure according to an exemplary embodiment of the present invention. Referring to FIG. 8, the document tree is to divide, group and reconstruct the DOM tree, and is to provide the attribute. Among the symbols, B a second component that is a semantically related semantic block component, C indicates a first component, and D a third component.

In the DOM tree of FIG. 5 compared to the document tree of FIG. 8, the DOM tree presents a layered structure based on the tag unlike a document structure recognized by a user. For this reason, it is not until the user goes through several levels of the DOM tree that he/she can access the document content 710. Further, although many pieces of content have the same type, they are not frequently located at the same level of the DOM tree. Consequently, the pieces of content having the same type are often separated and presented on the DOM tree, so that they cannot adaptively cope with the browsing environment.

In contrast, referring to FIG. 8, the document tree according to the exemplary embodiment of the present invention not only has a content-based component structure, but also is designed so that the first, second and third components have a layered structure, and that semantically related components are grouped and reconstructed. Thus, unlike the DOM tree illustrated in FIG. 5, the document tree provides easy access to each document content C. Further, the pieces of content having the same type are located at the same level of the document tree, and can be provided with the attribute suitable for the browsing environment according to the component group. As a result, the documents can be adaptively presented even in various browsing environments. Further, specific information is easily searched and extracted using the content-based component structure.

The rendering engine 20 renders the documents to a display screen on the basis of the illustrated document tree according to the attribute provided to the respective first components or the grouped second components so as to be suitable for the browsing environment.

As described above, according to the exemplary embodiment of the present invention, the document tree having the content-based component structure can be generated to adjust the content and components provided to the users in real time, so that the browsing method and apparatus can be useful for various web browsing environments. For example, even in the case in which existing web documents cannot be presented as they stand due to a different browsing environment such as a platform or a display device, the browsing method according to the exemplary embodiment of the present invention is used to enable the web documents to be adaptively presented so as to be adaptive to the browsing environment without having to reproduce the web documents. Further, the web documents are modeled according to the component using the semantic relation between the content-based components, so that content-oriented service of extracting more accurate information can be provided to the applications such as personalized web pages having different constructions according to an individual taste, information search in which the results must be presented by request of the user, and so on.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A method for browsing content-based documents, comprising:
analyzing documents to generate a document tree on the basis of content-based components; and
presenting the documents on the basis of the generated document tree to be adaptive to a browsing environment.

2. The method of claim 1, wherein the generating of the document tree comprises:
grouping the content-based components into at least one component group according to a semantic relation; and
providing the component group with at least one attribute suitable for the browsing environment.

3. The method of claim 2, wherein the generating of the document tree further comprises adjusting a presentation priority for the content-based components or the component groups to be suitable for the browsing environment.

4. The method of claim 2, wherein the presenting of the documents comprises rendering the documents on the basis of the generated document tree according to the attribute provided to be suitable for the browsing environment.

5. The method of claim 2, wherein the attribute provided to be suitable for the browsing environment comprises at least one of a layout, a presentation style, and a content format.

6. The method of claim 1, further comprising searching or extracting information of a specific content from the documents on the basis of the generated document tree.

7. The method of claim 2, wherein the grouping of the content-based components comprises incorporating the plurality of content-based components into a representative component node in a parallel arrangement according to similarity such that the document tree has a flat structure.

8. The method of claim 7, wherein the representative component node comprises summary information on the content of the plurality of content-based components.

9. The method of claim 7, wherein the representative component node comprises information on exposure levels of the plurality of content-based components.

10. The method of claim 2, wherein the grouping of the content-based components comprises grouping the components having the semantic relation into at least one component group using layouts or repeated patterns of the plurality of content-based components

11. An apparatus for browsing content-based documents, comprising:
a browser engine for analyzing documents to generate a document tree on the basis of content-based components; and
a rendering engine for presenting the documents on the basis of the generated document tree to be adaptive to a browsing environment.

12. The apparatus of claim 11; wherein the browser engine groups the content-based components into at least one component group according to a semantic relation, and provides the component group with at least one attribute suitable for the browsing environment.

13. The apparatus of claim 12, wherein the browser engine adjusts a presentation priority for the content-based components or the component groups to be suitable for the browsing environment.

14. The apparatus of claim 12, wherein the rendering engine renders the documents on the basis of the generated document tree according to the attribute provided to be suitable for the browsing environment.

15. The apparatus of claim 11, wherein the browser engine searches or extracts information of a specific content from the documents on the basis of the generated document tree.

16. A mobile terminal on which an apparatus for browsing content-based documents is mounted, the apparatus comprising:
a browser engine for analyzing documents to generate a document tree on the basis of content-based components; and
a rendering engine for presenting the documents on the basis of the generated document tree to be adaptive to a browsing environment.

17. An Internet protocol television (IPTV) on which an apparatus for browsing content-based documents is mounted, the apparatus comprising:
a browser engine for analyzing documents to generate a document tree on the basis of content-based components; and
a rendering engine for presenting the documents on the basis of the generated document tree to be adaptive to a browsing environment.
